(19) United States
(12) Patent Application Publication
(10) Pub. No.: US 2017/0072351 A1
(43) Pub. Date: Mar. 16, 2017

(54) Solid/Fluid Separator and Method of Manufacture

(71) Applicant: Global Fabrication, Inc., DuBois, PA (US)

(72) Inventors: Dennis V. Raybuck, DuBois, PA (US); Luke C. Sicard, DuBois, PA (US)

(73) Assignee: Global Fabrication, Inc., DuBois, PA (US)

(21) Appl. No.: 15/257,948

(22) Filed: Sep. 7, 2016

Related U.S. Application Data
(60) Provisional application No. 62/217,058, filed on Sep. 11, 2015.

(51) Int. Cl. B01D 45/08

(52) U.S. Cl. CPC B01D 45/08

(57) ABSTRACT

A solid/fluid separator is provided. The solid/fluid separator is designed so as to be constructed and repaired in a less expensive and time consuming manner. That is, the disclosed and claimed concept provides a solid/fluid separator that does not include domed ends and/or any welding of the main equipment body. In the disclosed and claimed concept the solid/fluid separator includes a uniform cylinder machined on each end to accept a high pressure gasket and a generally flat, i.e., not domed, head assembly. Further, the head assembly is bolted to the cylinder using either high strength studs and nuts or specially designed bolts. By eliminating any welding on the main equipment body, the need for post weld heat treatment and x-ray inspection is eliminated.

### CROSS REFERENCE TO RELATED APPLICATION

This application is claims priority to U.S. Provisional Patent Application Ser. No. 62/217,058, filed Sep. 11, 2015, entitled SOLID/FLUID SEPARATOR AND METHOD OF MANUFACTURE.

### BACKGROUND OF THE INVENTION

Field of the Invention

The disclosed and claimed concept relates to a solid/fluid separator and, more specifically, to a solid/fluid separator that does not include welded pressure elements.

Background Information

A solid/fluid separator is structured to separate solids, such as, but not limited to sand and other particulate materials, that are incorporated into a flowing fluid. The fluid may be a liquid or a gas. Generally, a high speed mixed flow travelling through an inlet conduit is introduced into an enclosed space, which may include diverters or similar elements. The enclosed space is larger, i.e. has a greater cross-sectional area, than the conduit through which the mixed flow was traveling. Accordingly, when the mixed flow enters the enclosed space, the speed of the flow is reduced allowing the heavier solids to separate from the flow and fall to the bottom of the enclosed space. Further, the solids may impinge upon the diverters, or similar elements, thereby reducing their momentum and allowing the solids to separate from the flow. The enclosed space may include a liquid at the bottom to further entrap the solids. The fluid then leaves the enclosed space via an outlet conduit.

In the past, separation equipment was made by welding domes to each end of a cylindrical body so as to define the enclosed space. The domes were generally 2:1 elliptical domes, dished or spherical. The finished equipment must be x-ray inspected, undergo post weld heat treatment (heating the assembly up to 1250 degrees F. and then cooling if back down in specific increments) and pressure tested under up to 15,000 psig. This made the only way of servicing the equipment to be cutting it apart, repairing the inside parts that were malfunctioning and then welding the system back together again and performing the other x-ray, post weld heat treatment and pressure testing all over again. This is a time consuming and expensive prospect both for the original manufacturer and for any repairs.

There is, therefore, a need for a solid/fluid separator that is designed so as to be constructed and repaired in a less expensive and time consuming manner.

### SUMMARY OF THE INVENTION

The disclosed and claimed concept provides a solid/fluid separator that is designed so as to be constructed and repaired in a less expensive and time consuming manner. That is, the disclosed and claimed concept provides a solid/fluid separator that does not include domed ends and/or any welding of the main equipment body. In the disclosed and claimed concept the solid/fluid separator includes a uniform cylinder machined on each end to accept a high pressure gasket and a generally flat, i.e. not domed, head assembly. Further, the head assembly is bolted to the cylinder using either high strength studs and nuts or specially designed bolts. By eliminating any welding on the main equipment body, the need for post weld heat treatment and x-ray inspection is also eliminated. That is, the disclosed configuration solves the testing problems stated above.

Further, the inflow and outflow piping will be threaded into the main equipment body thereby eliminating additional welds. In this configuration, the production time to build this system is reduced from 10 days to 5 hours. The disclosed configuration solves the time and expense problems stated above. In addition, the disclosed and claimed concept allows for easy repair of the system; when a problem arises all that needs to be done is the disassembly of the elements noted above, repair and reassembly. As the elements are bolted, the need for post weld heat treatment and x-ray inspection necessary for the current designs is eliminated.

A solid/fluid separator in the configuration(s) discussed below solves the stated problems.

### BRIEF DESCRIPTION OF THE DRAWINGS

A full understanding of the invention can be gained from the following description of the preferred embodiments when read in conjunction with the accompanying drawings in which:

FIG. 1 is an exploded isometric view of a solid/fluid separator.

FIG. 2 is an isometric view of a velocity reduction device

FIG. 3 is another isometric view of a velocity reduction device.

### DESCRIPTION OF THE PREFERRED EMBODIMENTS

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, the word “unitary” means a component is created as a single piece or unit. That is, a component that includes pieces that are created separately and then coupled together as a unit is not a “unitary” component or body. Further, as used herein, the portions or elements of a “unitary” body are “coupled” together.

As used herein, a “coupling assembly” includes two or more couplings or coupling components. The components of a coupling or coupling assembly are generally not part of the same element or other component. As such, the components of a “coupling assembly” may not be described at the same time in the following description.

As used herein, a “coupling” or “coupling component(s)” is one or more component(s) of a coupling assembly. That is, a coupling assembly includes at least two components that are structured to be coupled together. It is understood that the components of a coupling assembly are compatible with each other. For example, in a coupling assembly, if one coupling component is a snap socket, the other coupling component is a snap plug, or, if one coupling component is a bolt, then the other coupling component is a nut. It is further understood that an opening or passage through which another coupling component extends is also a coupling component.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, a first object resting on a second object, which is held in place only by gravity, is not “coupled” to the second object unless the first object is otherwise linked to the second object. That is, for example, a book on a table is not coupled thereto, but a book glued to a table is coupled thereto.

As used herein, “temporarily coupled” means that two components are coupled in a manner that allows for the components to be easily decoupled without damaging the components. For example, elements that are coupled by a nut/bolt coupling are “temporarily coupled,” while elements that are welded together are not.

As used herein, the statement that two or more parts or components “engage” one another shall mean that the elements exert a force or bias against one another either directly or through one or more intermediate elements or components.

As used herein, “operatively engage” means “engage and move.” That is, “operatively engage” when used in relation to a first component that is structured to move a movable or rotatable second component means that the first component applies a force sufficient to cause the second component to move. For example, a screwdriver may be placed into contact with a screw. When no force is applied to the screwdriver, the screwdriver is merely “coupled” to the screw. If an axial force is applied to the screwdriver, the screwdriver is pressed against the screw and “engages” the screw; however, when a rotational force is applied to the screwdriver, the screwdriver “operatively engages” the screw and causes the screw to rotate. As used herein, “operatively engage” means “engage and maintain in a selected position.” That is, a compressed spring held in place by a latch is “operatively engaged” by the latch in that the latch maintains the spring in a compressed state.

As used herein, the term “number” shall mean one or an integer greater than one (i.e., a plurality).

As used herein, “associated” means that the elements are part of the same assembly and/or operate together, or, act upon/with each other in sonic manner. For example, an automobile has four tires and four hub caps. While all the elements are coupled as part of the automobile, it is understood that each hubcap is “associated” with a specific tire.

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are said to fit “snugly” together or “snuggly correspond.” In that situation, the difference between the size of the components is even smaller whereby the amount of friction increases. If the element defining the opening and/or the component inserted into the opening is made from a deformable or compressible material, the opening may even be slightly smaller than the component being inserted into the opening. This definition is further modified if the two components are said to “substantially correspond.” “Substantially correspond” means that the size of the opening is very close to the size of the element inserted therein; that is, not so close as to cause substantial friction, as with a snug fit, but with more contact and friction than a “corresponding fit,” i.e., a “slightly larger” fit. Further, as used herein, “loosely correspond” means that a slot or opening is sized to be larger than an element disposed therein. This means that the increased size of the slot or opening is intentional and is more than a manufacturing tolerance. Further, with regard to a surface formed by two or more elements, a “corresponding” shape means that surface features, e.g. curvature, are similar.

As used herein, “structured to [verb] or ‘be an [X]’” means that the identified element or assembly has a structure that is shaped, sized, disposed, coupled and/or configured to perform the identified verb or to be what is identified in the infinitive phrase. For example, a member that is “structured to move” is movably coupled to another element and includes elements that cause the member to move or the member is otherwise configured to move in response to other elements or assemblies. As such, as used herein, “structured to [verb] or ‘be an [X]’” recites structure and not function. Further, as used herein, “structured to [verb] or ‘be an [X]’” means that the identified element or assembly is intended to, and is designed to, perform the identified verb or to be an [X]. Thus, an element that is only possibly “capable” of performing the identified verb but which is not intended to, and is not designed to, perform the identified verb is not “structured to [verb] or ‘be an [X]’.”

As used herein, a “pressure element” is a structural element of a solid/fluid separator that is structured to maintain pressure within the solid/fluid separator primary chamber. Peripheral elements, both internal and external, are not structural elements of a solid/fluid separator. As used herein, “peripheral elements” are internal and external devices which are used for determining the correct internal flow distribution or vessel connections such as, but not limited to, piping, valves, control equipment and instrumentation

As used herein, a “primary coupling component” is a coupling component for the “pressure elements” of a solid/fluid separator. Thus, coupling components for peripheral elements are not “primary coupling components.”

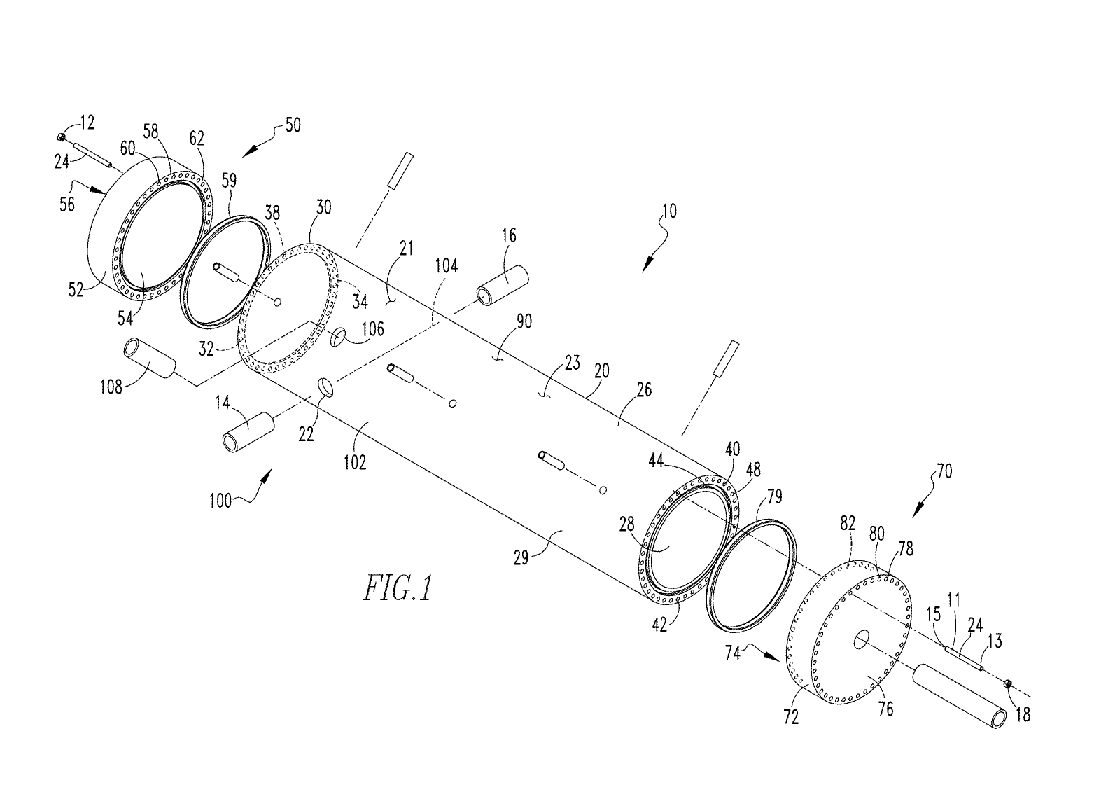

As shown in FIG. 1, a solid/fluid separator 10 includes a hollow, generally cylindrical housing 20, a number of first primary coupling components 24, a first head assembly 50, and a second head assembly 70. The housing 20 includes a generally planar first axial end 30, a generally planar second axial end 40, and a number of ports 22. The housing 20 includes a body 26 having an inner surface 28 and an outer surface 29. The ports 22 are generally radial passages through the housing 20. The ports 22 are, in an exemplary embodiment, generally circular passages which include threads (not shown). The ports 22 are structured to be coupled to conduits such as, but not limited to, a solids/fluid inlet conduit 14 and a fluid outlet conduit 16. In an exemplary embodiment, the ports 22 are structured to be coupled to the solids/fluid inlet conduit 14 and the fluid outlet conduit 16 are radial ports located generally radially opposite each other. Thus, there is an inlet port 22A and an outlet port 22B.

In an exemplary embodiment, each first primary coupling component 24 includes a generally cylindrical rod 11 with a corresponding nut 12. Each first primary coupling component rod 11 includes a first end 13 and a second end 15. The first primary coupling component rod first end 13 and second end 15 are threaded.

The housing first and second axial ends 30, 40 are substantially similar and only the first axial end 30 will be described. It is understood that the elements of the housing first axial end 30 include reference numbers in the thirties; thus, the similar elements of the housing second axial end 40 would be similar but in the forties. That is, for example, housing first axial end 30 includes a groove 34, thus housing second axial end 40 includes a groove 44.

The housing first axial end 30 includes a generally planar surface 32, a groove 34, and a number of second primary coupling components 36. The second primary coupling components 36 are, in an exemplary embodiment, threaded bores 38 that extend generally parallel to the longitudinal axis of housing 20. The second primary coupling components 36 are disposed in a generally circular pattern extending about, i.e. encircling, housing first axial end 30. In an exemplary embodiment, the second primary coupling components 36 are spaced between about 5 and 30 degrees apart, or about nine degrees apart, in an exemplary embodiment. Thus, on a housing 20 with an outer diameter of about 24 inches, there are about forty second primary coupling components 36 disposed about nine degrees apart from each other.

The housing first axial end groove 34 is a generally circular channel extending about, i.e. encircling, housing first axial end 30. The housing first axial end groove 34 is disposed radially inwardly of the second primary coupling components 36. The housing first axial end groove 34 is sized to correspond to the seal member 59, discussed below.

It is noted that the housing 20 does not include a flange structured to be coupled to primary coupling components.

In an exemplary embodiment, the first head assembly 50 includes a generally planar member 52 and a seal member 59. The first head assembly planar member 52 is generally circular and generally corresponds to the housing 20. That is, the first head assembly planar member 52 has generally the same radius as the housing 20. The first head assembly planar member 52 includes an inner, first axial side 54, an outer, second axial side 56 and a number of third primary coupling components 58. The third primary coupling components 58 are, in an exemplary embodiment, are a number of passages 60 extending between the first head assembly planar member first axial side 54 and the first head assembly planar member second axial side 56. In an exemplary embodiment, the third primary coupling component passages 60 extend generally normal to the first head assembly planar member first axial side 54 and the first head assembly planar member second axial side 56. The third primary coupling component passages 60 correspond to the first primary coupling components 24.

The first head assembly planar member first axial side 54 includes a groove 62. The first head assembly groove 62 is a generally circular channel extending about, i.e. encircling, first head assembly planar member 52. The first head assembly groove 62 is disposed radially inwardly of the third primary coupling components 58. The first head assembly groove 62 is sized to correspond to the first head assembly seal member 59. The housing first axial end groove 34 and the first head assembly groove 62 have substantially the same radius.

The first head assembly seal 59 is generally rigid and, in an exemplary embodiment, is made from the same material, and in an exemplary embodiment, the same metal, as housing 20, or, in an alternate embodiment, a different high strength metal. The first head assembly seal 59 has generally the same radius as the first axial end groove 34 and the first head assembly groove 62.

It is noted that the first head assembly 50 does not include a flange structured to be coupled to primary coupling components 24.

In an exemplary embodiment, the second head assembly 70 includes a generally planar member 72 and a seal member 79. The second head assembly planar member 72 is generally circular and generally corresponds to the housing 20. That is, the second head assembly planar member 72 has generally the same radius as the housing 20. The second head assembly planar member 72 includes an inner, first axial side 74, an outer, second axial side 76 and a number of third primary coupling components 78. The third primary coupling components 78 are, in an exemplary embodiment, are a number of passages 80 extending between the second head assembly planar member first axial side 74 and the second head assembly planar member second axial side 76. In an exemplary embodiment, the third primary coupling component passages 80 extend generally normal to the second head assembly planar member first axial side 74 and the second head assembly planar member second axial side 76. The third primary coupling component passages 80 correspond to the first primary coupling components 24.

In an exemplary embodiment, the second head assembly planar member 72 also include a central passage 88 that is threaded. The central passage 88 extends between the second head assembly planar member first axial side 74 and the second head assembly planar member second axial side 76. In an exemplary embodiment, the central passage 88 extends generally normal to the second head assembly planar member first axial side 74 and the second head assembly planar member second axial side 76. The central passage 88 is structured to be coupled to a solids conduit 17.

The second head assembly planar member first axial side 74 includes a groove 82. The second head assembly groove 82 is a generally circular channel extending about, i.e. encircling, second head assembly planar member 72. The second head assembly groove 82 is disposed radially inwardly of the third primary coupling components 78. The second head assembly groove 82 is sized to correspond to the second head assembly seal member 79. The housing first axial end groove 34 and the second head assembly groove 82 have substantially the same radius.

The second head assembly seal member 79 is generally rigid and, in an exemplary embodiment, is made from the same material, and in an exemplary embodiment, the same metal, as housing 20, or, in an alternate embodiment, a different high strength metal. The second head assembly seal member 79 has generally the same radius as the first axial end groove 34 and the second head assembly groove 82.

It is noted that the second head assembly 70 does not include a flange structured to be coupled to primary coupling components 24.

The solid/fluid separator 10 is assembled as follows. The first head assembly seal ember 59 is disposed in the housing first axial end groove 34. The first head assembly planar member 52 is disposed on the housing first axial end 30 with the first head assembly planar member first axial side 54 disposed adjacent, and in an exemplary embodiment against, the housing first axial end surface 32. In this configuration, the first head assembly seal member 59 is also disposed in the first head assembly groove 62. A number of first primary coupling components 24 are passed through the first head assembly planar member third primary coupling components 58 and each first primary coupling component rod second end 15 is threaded into a housing first axial end second primary coupling components 36. A first primary coupling component nut 12 is then threaded onto each first primary coupling component rod first end 13. The primary coupling component nuts 12 are tightened in a selected order thereby sealing the first head assembly 50 to the housing 20. The second head assembly 70 is coupled to the housing second axial end 40 in a substantially similar order with the second head assembly seal member 79 disposed in the housing second axial end groove 44 and with the second head assembly planar member first axial side 74 disposed adjacent to, and in an exemplary embodiment, against, the housing second axial end surface 42.

In this configuration, the housing 20, the first head assembly 30 and the second head assembly 40 define an enclosed space 90. Further, the housing 20, the first head assembly 30 and the second head assembly 40 are the primary elements that are structured to maintain the pressure within the housing enclosed space 90. As used herein, and for the embodiment described above, these elements, i.e. the housing 20, the first head assembly 30 and the second head assembly 40, are the “pressure elements.” Further, the first head assembly 30 is not welded to the housing 20 and the second head assembly 40 is not welded to housing 20. That is, no pressure element is welded to another pressure element. Thus, the pressure elements are temporarily coupled as defined herein. Further, as noted above, none of the pressure elements include a primary coupling flange. That is, as used herein, a “primary coupling flange” is a flange used to couple pressure elements to each other. Further, the solid/fluid separator 10 in this configuration does not include domed ends.

Thus, a method of assembling the solid/fluid separator 10 includes providing 1000 a hollow, generally cylindrical housing 20, providing 1002 a number of primary first primary coupling components 24, providing 1004 a first head assembly 50, providing 1006 a second head assembly 70, coupling 1008 a number of primary first primary coupling components 24 to the first axial end second primary coupling components 36 and the first head assembly third primary coupling components 58, wherein the first head assembly 50 is sealingly coupled to the housing first axial end 30, and coupling 1010 a number of primary first primary coupling components 24 to the second axial end second primary coupling components 46 and second head assembly third primary coupling components 78, wherein the second head assembly 70 is sealingly coupled to the housing second axial end 40. Providing 1000 a hollow, generally cylindrical housing 20 includes providing 1020 a housing 20 with a number of threaded ports 22.

It is noted that in this method there is no step of welding the first head assembly 50 to the housing 20 and no step of welding the second head assembly 70 to the housing 20. That is, there is no step of welding a pressure element to another pressure element.

As noted above, the assembly of the solid/fluid separator 10 includes disposing 1030 the first head assembly planar member first axial side 54 adjacent the housing first axial end 30 and disposing 1032 the first head assembly seal member 59 in both the first head assembly planar member first axial side groove 62 and the housing first axial end groove 34. Similarly, the assembly of the solid/fluid separator 10 includes disposing 0 the second head assembly planar member first axial side 74 adjacent the housing second axial end 40 and disposing 2 the second head assembly seal member 79 in both the second head assembly planar member first axial side groove 82 and the housing second axial end groove 44.

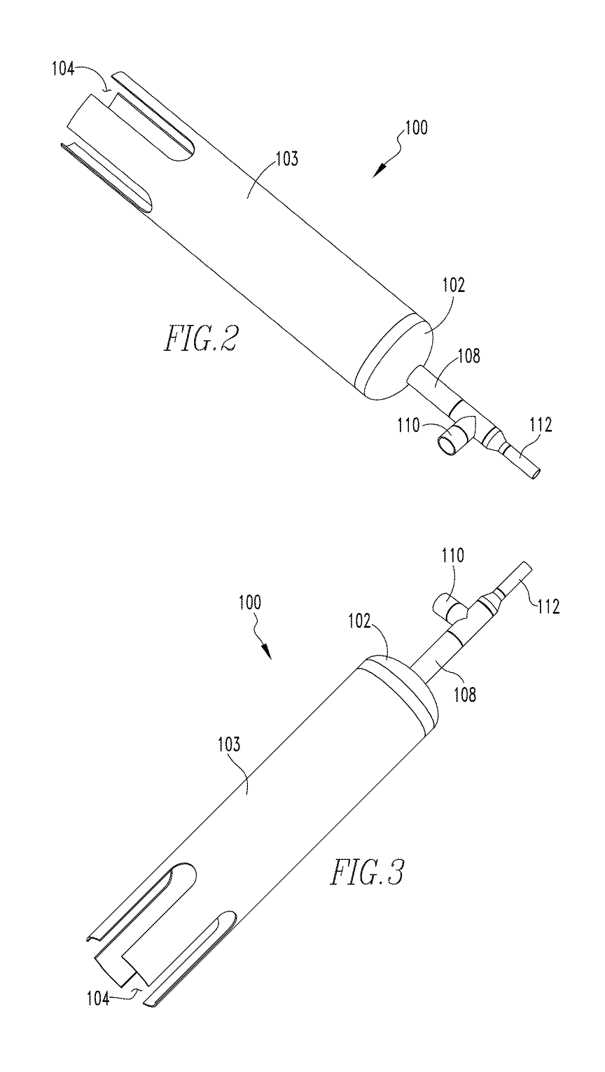

In an exemplary embodiment, as shown in FIGS. 2 and 3, the solid/fluid separator 10, or the housing 20, includes a velocity reduction device 100. The velocity reduction device 100 is disposed within the space defined by the housing 20. The velocity reduction device 100 includes a domed body 102 structured to direct incoming fluid to the housing body inner surface 28. The domed body 102 may be any type of dome and is shown schematically as an elliptical dome. The domed body 102 is, in an exemplary embodiment, coupled to, or unitary with, a depending skirt 103. The skirt 103 includes cutouts 104 that are in fluid communication with the lower portion of the housing 20. The radius of the domed body 102 and skirt 103 is slightly smaller than the cross-sectional area of housing body inner surface 28. In an alternate exemplary embodiment, the velocity reduction device 100 also includes a separator plate (not shown) disposed adjacent and above the domed body 102. In an exemplary embodiment, the separator plate is slightly smaller than the cross-sectional area of housing body inner surface 28. The domed body 102 and/or the separator plate divides the housing 20 and enclosed space 90 into an upper portion 21 and a lower portion 23. The separator plate includes a plurality of slots (not shown).

The domed body 102 also includes an opening 106 in fluid communication with a generally vertical and upwardly extending exhaust pipe 108. The exhaust pipe 108 includes a “T” with an exhaust branch 110 and a pressurizing branch 112. In an exemplary embodiment, the exhaust branch 110 has a larger diameter than the pressurizing branch 112. The exhaust branch 110 extends generally radially and is in fluid communication with the outlet port 228 and the fluid outlet conduit 16. The pressurizing branch 112 extends generally vertically, i.e. axially in the housing 20. In an embodiment with a separator plate, the exhaust pipe 108/pressurizing branch 112 extend through the separator plate.

The lower end of the domed body 102, or the skirt 103, is adjacent the generally open, lower portion 23 of the housing 20. That is, the interior space at housing lower portion 23 does not include any substantial structures (other than the velocity reduction device 100 which is disposed at the upper end of the housing lower portion. The solids/fluid inlet conduit 14 is disposed adjacent to the upper surface of the domed body 102 and below the separator plate . The fluid outlet conduit 16 is disposed above the separator plate. In an exemplary embodiment, the lower portion 23 of the housing 20 also encloses a quantity of water.

In use and in this configuration, sand and any other particulates in the fluid flow enter the housing 20 adjacent the upper surface of the domed body 102 and impact on the velocity reduction device 100, thereby slowing the particles. The solids and fluid move downward over the domed body 102 and skirt 103 and into the interior space at housing lower portion 23 that does not include any substantial structures. That is, the solids and fluid pass through the cutouts 104 into the interior space at housing lower portion 23. Because the interior space at housing lower portion 23 has a much larger cross-sectional area relative to the solids/fluid inlet conduit 14, the speed of the fluid is reduced. With the speed of the fluid reduced, and due to a loss of momentum from impacting the domed body 102, sand and other particles are no longer carried by the fluid flow and fall into the water in the housing lower portion 23.

The remaining fluid, and possibly some of the water, exits the housing lower portion 23 bypassing upwardly through the domed body opening 106 and exhaust pipe 108 into the housing upper portion 21. In exhaust pipe 108 the gas flow is split with a larger portion passing through exhaust branch 110 and out of housing 20. A smaller portion of the gas flow passes through pressurizing branch 112 and into the housing upper portion 21. The fluid in the housing upper portion 21 pressurizes the housing upper portion 21, thereby maintaining both the housing upper portion 21 and the housing lower portion 23 at pressure. Further, the in the housing upper portion 21 then fluid passes downwardly through separator plate and over domed body 102 toward housing lower portion 23. Thus, the pressurizing fluid assists in directing the flow of the incoming fluid/solid mixture toward the housing lower portion 23.

That is, when the fluid that is substantially free of sand and other particulates rises up the inside of the velocity reduction device 100 to enter the fluid outlet conduit 16, a portion of the fluid bypasses the fluid outlet conduit 16 thereby pressurizing the housing upper portion 21 and forcing a pressurized gas to flow downward and mix with the incoming gas and particulates entering enclosed space 90 via solids/fluid inlet conduit 14. Thus, a portion of the already processed fluid is recirculated and ensures that the inflow of gas with particulates does not migrate to the top of the solid/fluid separator 10.

Further, in an exemplary embodiment, the pressure elements, i.e. the housing 20, the first head assembly 30 and the second head assembly 40, as well as the elements of the velocity reduction device 100 are made from a family of metals identified as chrome moly and include both A5194130 and A5194140, as is known in the art. Further, in an exemplary embodiment, the pressure elements and the elements of the velocity reduction device 100 are further hardened by applying 1100 an even harder material to any wear surface via a welding procedure. As used herein, a “wear surface” is any surface that is impacted by sand and/or particles in the fluid flow.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A solid/fluid separator comprising:
a hollow, generally cylindrical housing;
said housing having a generally planar first axial end, a generally planar second axial end, and a number of ports;
a number of primary first primary coupling components;
said housing first axial end including a number of second primary coupling components;
said housing second axial end including a number of second primary coupling components;
a first head assembly, said first head assembly including a number of third primary coupling components;
a second head assembly, said second first head assembly including a number of third primary coupling components;
a number of said primary first primary coupling components coupled to said first axial end second primary coupling components and said first head assembly third primary coupling components, wherein said first head assembly is sealingly coupled to said housing first axial end; and
a number of said primary first primary coupling components coupled to said second axial end second primary coupling components and said second head assembly third primary coupling components, wherein said second head assembly is sealingly coupled to said housing second axial end.

2. The solid/fluid separator of claim 1 wherein:
said first head assembly is not welded to said housing; and
said second head assembly is not welded to said housing.

3. The solid/fluid separator of claim 1 wherein a number of said ports are threaded.

4. The solid/fluid separator of claim 1 wherein no pressure element is welded to another pressure element and no pressure element includes a primary coupling flange.

5. The solid/fluid separator of claim 1 wherein:
said housing first axial end including a circumferential groove;
said first head assembly includes a generally planar member and a seal member;
said first head assembly planar member including a first axial side;
said first head assembly planar member first axial side including a circumferential groove;
wherein said first head assembly seal member is generally circular;
said first head assembly planar member first axial side disposed adjacent said housing first axial end;
said first head assembly seal member disposed in both said first head assembly planar member first axial side groove disposed adjacent said housing first axial end groove;
said housing second axial end including a circumferential groove;
said second head assembly includes a generally planar member and a seal member;
said second head assembly planar member including a first axial side;
said second head assembly planar member first axial side including a circumferential groove;
wherein said second head assembly seal member is generally circular;
said second head assembly planar member first axial side disposed adjacent said housing second axial end; and
said second head assembly seal member disposed in both said second head assembly planar member first axial side groove disposed adjacent said housing second axial end groove.

6. The solid/fluid separator of claim 1 wherein:
said housing includes and inlet port and an outlet port;
said housing includes a velocity reduction device, said velocity reduction device including a domed body;
said domed body dividing said housing enclosed space into an upper portion and a lower portion;
said inlet port in fluid communication with said housing upper portion; and
wherein incoming fluid and particles impact on said domed body.

7. The solid/fluid separator of claim 6 wherein:
said velocity reduction device includes an opening and an exhaust pipe;
said exhaust pipe in fluid communication with said outlet port;
said exhaust pipe extending generally vertically from said domed body; and
said exhaust pipe in fluid communication with said outlet port.

8. The solid/fluid separator of claim 7 wherein:
said exhaust pipe includes an exhaust branch and a pressurizing branch;
said exhaust branch in fluid communication with said outlet port; and
said pressurizing branch in fluid communication with said housing upper portion.

9. A method of assembly a solid/fluid separator including:
providing a hollow, generally cylindrical housing;
said housing having a generally planar first axial end, a generally planar second axial end, and a number of ports;
said housing first axial end including a number of second primary coupling components;
said housing second axial end including a number of second primary coupling components;
providing a number of primary first primary coupling components;
providing a first head assembly, said first head assembly including a number of third primary coupling components;
providing a second head assembly, said second first head assembly including number of third primary coupling components;
coupling a number of said first primary coupling components to said first axial end second primary coupling components and said first head assembly third primary coupling components, wherein said first head assembly is sealingly coupled to said housing first axial end; and
coupling a number of said first primary coupling components to said second axial end second primary coupling components and said second head assembly third primary coupling components, wherein said second head assembly is sealingly coupled to said housing second axial end.

10. The method of claim 9 wherein:
there is no step of welding said first head assembly to said housing; and
there is no step of welding said second head assembly to said housing.

11. The method of claim 9 wherein providing a hollow, generally cylindrical housing includes providing a housing with a number threaded ports.

12. The method of claim 9 wherein there is no step of welding a pressure element to another pressure element.

13. The method of claim 9 wherein coupling a number of said first primary coupling components to said first axial end second primary coupling components and said first head assembly third primary coupling components, wherein said first head assembly is sealingly coupled to said housing first axial end and coupling a number of said first primary coupling components to said second axial end second primary coupling components and said second head assembly third primary coupling components, wherein said second head assembly is sealingly coupled to said housing second axial end includes:
a housing first axial end including a circumferential groove;
a first head assembly including a generally planar member and a seal member;
said first head assembly planar member including a first axial side;
said first head assembly planar member first axial side including a circumferential groove;
wherein said first head assembly seal member is generally circular;
disposing said first head assembly planar member first axial side adjacent said housing first axial end;
disposing said first head assembly seal member in both said first head assembly planar member first axial side groove and said housing first axial end groove;
said housing second axial end including a circumferential groove;
said second head assembly includes a generally planar member and a seal member;
said second head assembly planar member including a first axial side;
said second head assembly planar member first axial side including a circumferential groove;
wherein said second head assembly seal member is generally circular;
disposing said second head assembly planar member first axial side adjacent said housing second axial end; and
disposing said second head assembly seal member in both said second head assembly planar member first axial side groove and said housing second axial end groove.
